(19) United States
(12) Patent Application Publication
(10) Pub. No.: US 2002/0089404 A1
(43) Pub. Date: Jul. 11, 2002

(54) Flyback transformer

(75) Inventors: Kenji Naito, Yasu-gun (JP); Masahiko Kitamoto, Kurita-gun (JP); Tadao Nagai, Yasu-gun (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/939,285

(22) Filed: Aug. 24, 2001

(30) Foreign Application Priority Data
Aug. 31, 2000 (JP) 2000-262841

(51) Int. Cl. H01F 27/28

(52) U.S. Cl. 336/182

(57) ABSTRACT

A flyback transformer includes a coil having a secondary multi-layered winding. A dividing diode has a plurality of diodes. The diodes are connected between each of multi-layered winding portions of the secondary winding. The respective diodes are connected between the low potential-side and the high potential-side of the secondary winding. A dynamic focus capacitor is connected to an input portion into which a parabolic signal for obtaining a dynamic focus output is input. In one embodiment, the dynamic focus capacitor is disposed near the central portion of the winding length of the secondary winding, that is, near the AC zero potential point.

### BACKGROUND OF THE INVENTION

1. Field of the Invention

The present invention generally relates to flyback transformers, and more particularly, to a flyback transformer including a coil having a secondary multi-layered winding divided by diodes, another diode being connected to the low potential-side of the secondary winding.

2. Description of the Related Art

FIG. 4 illustrates an example of a conventional flyback transformer. The flyback transformer 10 includes a coil 12. In the coil 12, as shown in FIG. 5, a primary winding 14 and a secondary winding 16 are wound. The secondary winding 16 is wound in a multi-layered form, and diodes D1 through D5 are connected between each of multi-layered winding portions. A diode D0 is connected between the low potential-side of the secondary winding 16 and ground. The high potential-side of the secondary winding 16 is connected to a voltage divider circuit 18 via a diode D6. A focus output is obtained from the voltage divider circuit 18. A dynamic focus capacitor 20 is connected to an input portion into which a parabolic signal is input so that the focus output can be superimposed on the parabolic signal, thereby increasing the dynamic focus output.

The diodes D0 through D6 are arranged side by side, as shown in FIG. 6, outside a bobbin 22 around which the secondary winding 16 is wound. The coil 12 is housed in a casing 24, as shown in FIG. 4, and a core 26 is arranged to pass through the center of the secondary winding 16. The voltage divider circuit 18 and the dynamic focus capacitor 20 are also housed in the casing 24.

In the above-configured flyback transformer 10, a flyback pulse is input into the primary winding 14 so as to generate a high voltage in the secondary winding 16. Then, a parabolic signal is superimposed on the output divided by the voltage dividing circuit 18, thereby obtaining a dynamic focus output. The dynamic focus output is then provided to a cathode ray tube (CRT). In the flyback transformer 10 in which the diode D0 is connected to the low potential-side of the secondary winding 16, the low potential-side of the secondary winding 16 is insulated from ground for an alternating current. Accordingly, the distributed capacitance anywhere between the primary winding 14 and the secondary winding 16 is uniform, as shown in FIG. 7. Thus, as shown in FIG. 8, the equivalent circuit of the secondary winding 16 can be considered as a lumped-constant circuit in which a capacitance having the same value is connected to each end of the secondary winding 16, and the center of the secondary winding 16 becomes an AC zero potential point which is grounded for an alternating current. Accordingly, a positive pulse is generated at one end of the secondary winding 16, while a negative pulse is generated at the other end. In the flyback transformer 10 constructed as described above, the center of the secondary winding 16 is grounded. Accordingly, it can be considered that a single winding is divided into two windings, that is, an upper winding and a lower winding, across the grounded center. Thus, a positive pulse and a negative pulse are generated across the AC zero potential point at the center of the secondary winding 16.

As described above, the positive and negative high-voltage pulses generated in the secondary winding 16 generate induced pulses in other components housed in the casing 24. If the induced pulses are generated in the dynamic focus capacitor 20, noise components are superimposed on a dynamic focus output waveform, as shown in FIG. 9. If a dynamic focus output with superimposed noise components is provided to a CRT, the resulting images will be distorted. Accordingly, the dynamic focus capacitor 20 is disposed away from the coil 12 so as to prevent pulses generated in the secondary winding 16 having an adverse influence.

However, this increases the size of the casing 24 for housing the coil 12 and the dynamic focus capacitor 20. Additionally, even if the dynamic focus capacitor 20 is disposed away from the coil 12, the adverse influence of pulses generated in the secondary winding 16 cannot be completely eliminated, which further requires the use of a correction circuit for eliminating the noise components.

### SUMMARY OF THE INVENTION

Accordingly, it is an object of the present invention to provide a compact flyback transformer which exhibits a low-noise dynamic focus output.

In order to achieve the above object, according to one aspect of the present invention, there is provided a flyback transformer including a coil which has a secondary multi-layered winding which is divided by a dividing diode. Another diode is connected to a low potential-side of the secondary multi-layered winding. A built-in component is disposed at a position corresponding to a central portion of a winding length of the coil.

According to another aspect of the present invention, there is provided a flyback transformer including a coil which has a secondary multi-layered winding which is divided by a dividing diode. Another diode is connected to a low potential-side of the secondary multi-layered winding. A built-in component is disposed in the vicinity of the dividing diode.

In the aforementioned flyback transformer, the built-in component may be a capacitor connected to an input portion into which a parabolic signal for obtaining a dynamic focus output is input.

According to the present invention, since the built-in component is disposed at a position corresponding to the central portion of the winding length of the secondary winding of the coil, it can be located in the vicinity of the AC zero potential point. Accordingly, positive pulses and negative pulses cancel each other, thereby inhibiting the generation of induced pulses in the built-in component. With the above arrangement, the built-in component can be located near the coil, and the overall flyback transformer can thus be reduced in size.

Concerning the diodes connected between each of the multi-layered winding portions of the secondary winding, pulses which have equivalent potentials to the positive and negative pulses in the secondary winding are generated at the leads of the diodes. However, such pulses contain only small AC pulse components due to the rectifying action of the diodes. Accordingly, the built-in component is disposed near the diodes, thereby suppressing the generation of induced pulses.

Even when the built-in component is disposed above or below the AC zero potential point, the generation of induced pulses can be prevented by disposing the diodes near the built-in component. In this case, the pulses generated in the secondary winding have opposite polarity to that of the pulses generated in the leads of the diodes.

In the above-described flyback transformer, a dynamic focus capacitor may be disposed in the manner discussed above as the built-in component, and noise superimposed on a parabolic waveform of a dynamic focus output can be suppressed, thereby preventing the disturbance of CRT images.

Further objects, features and advantages of the present invention will become apparent from the following description of the preferred embodiment with reference to the attached drawings.

### BRIEF DESCRIPTION OF THE DRAWING(S)

FIG. 1 illustrates an example of a flyback transformer according to the present invention;

FIG. 2 illustrates another example of a flyback transformer according to the present invention;

FIG. 3 illustrates still another example of a flyback transformer according to the present invention;

FIG. 4 illustrates an example of a conventional flyback transformer;

FIG. 5 is a circuit diagram of a conventional flyback transformer;

FIG. 6 illustrates the positional relationships between a coil and diodes used in a conventional flyback transformer;

FIG. 7 illustrates a secondary winding of a conventional flyback transformer using a diode D0;

FIG. 8 is an equivalent circuit diagram illustrating the secondary winding shown in FIG. 7; and

FIG. 9 is a waveform diagram illustrating the relationships between an input parabolic signal, induction pulses, and a dynamic focus output.

### DETAILED DESCRIPTION OF EMBODIMENTS OF THE INVENTION

The present invention is described in detail below with reference to the accompanying drawings through illustration of a preferred embodiment.

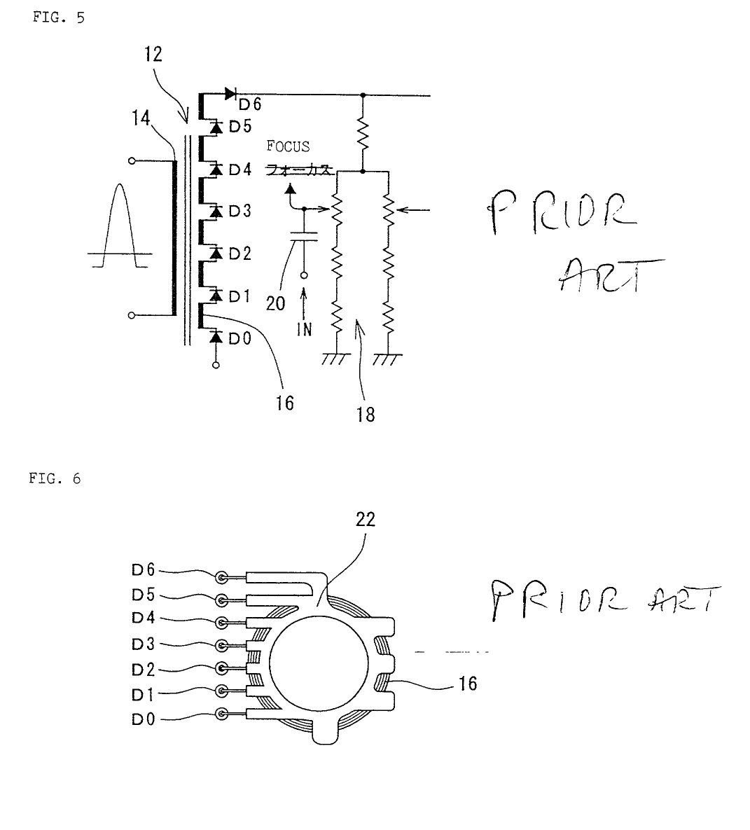

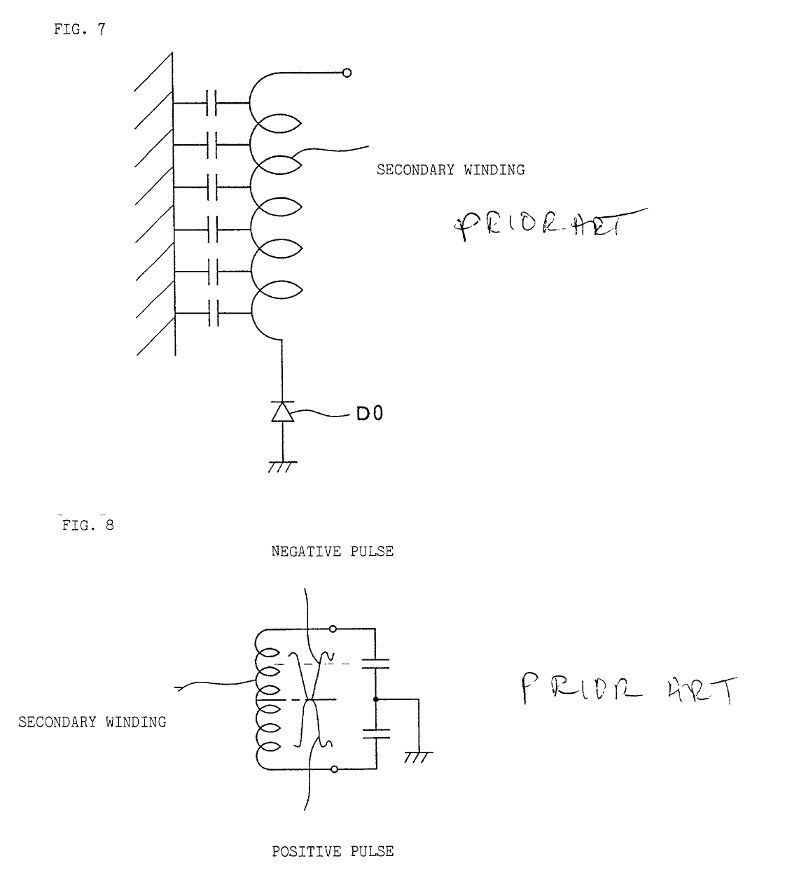

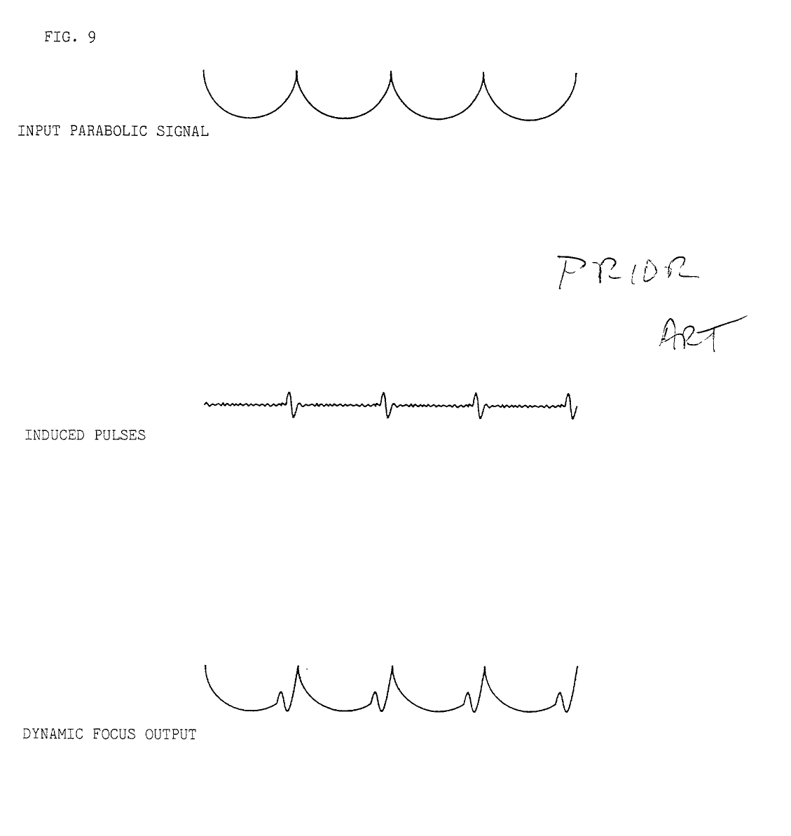

FIG. 1 illustrates an example of the internal configuration of a flyback transformer 10 of the present invention. The elements and the connecting relationships thereof are similar to those used in the flyback transformer 10 shown in FIGS. 4 and 5. In the flyback transformer 10 shown in FIG. 1, a partitioning wall 28 formed within a casing (not shown) is disposed between a coil 12 and a dynamic focus capacitor 20. The dynamic focus capacitor 20 is located at a position corresponding to the central portion of the winding length of a secondary winding 16 of the coil 12.

When a diode D0 is connected between the low potential-side of the secondary winding 16 and ground (as in FIG. 7), an AC zero potential point is formed at the central portion of the winding length of the secondary winding 16. A positive pulse and a negative pulse are then generated across the AC zero potential point. As stated above, the dynamic focus capacitor 20 is located at the central portion of the winding length of the secondary winding 16. It is thus located at a position corresponding to the AC zero potential point. Accordingly, positive pulse components and negative pulse components generated in the secondary winding 16 cancel each other, as indicated by the arrows shown in FIG. 1, thereby inhibiting noise components superimposed on a parabolic signal input via the dynamic focus capacitor 20. It is thus possible to obtain a low-noise dynamic focus output.

With the same number of turns of the secondary winding 16, the winding length becomes smaller as the number of multi-layers increases, thereby decreasing the voltage of the generated positive and negative pulses. Thus, with a greater number of multi-layers of the secondary winding 16, a low-noise dynamic focus output can be obtained.

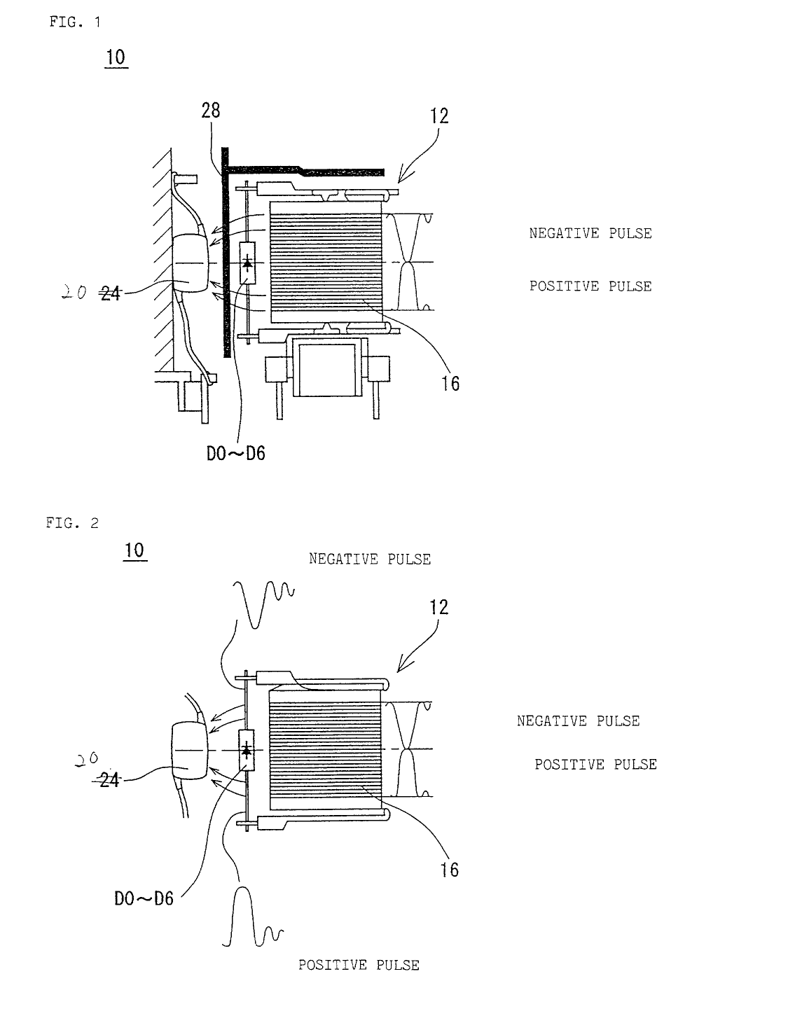

Alternatively, the dynamic focus capacitor 20 may be disposed, as shown in FIG. 2, in the vicinity of the diodes D0 through D6 connected between each of the multi-layered windings of the secondary winding 16. FIG. 2 illustrates the coil 12 in which the diodes D0 through D6 are disposed near the central portion of the winding length of the secondary winding 16. In this case, pulses which have equivalent potentials to those in the secondary winding 16 are generated at the leads of the diodes D0 through D6. However, such pulses contain only small AC pulse components due to the rectifying action of the diodes D0 through D6. Accordingly, the dynamic focus capacitor 20 is disposed near the diodes D0 through D6, thereby obtaining a low-noise dynamic focus output.

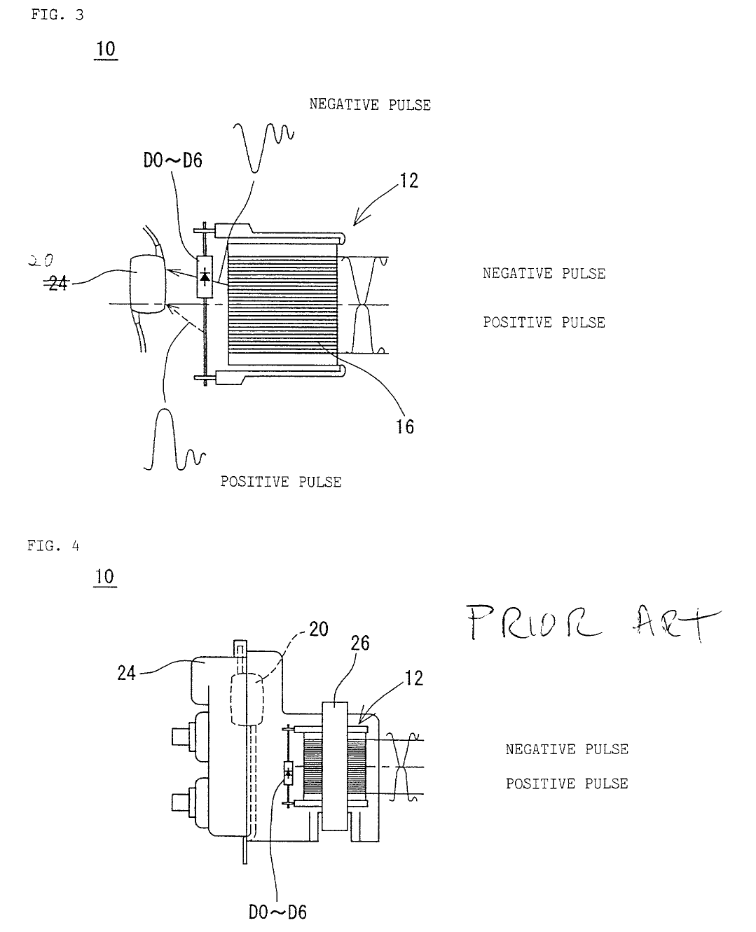

If the dynamic focus capacitor 20 is disposed above the AC zero potential point, as shown in FIG. 3, the input parabolic signal becomes more vulnerable to negative pulses generated in the secondary winding 16. However, the diodes D0 through D6 are disposed above the AC zero potential point so that they can be positioned close to the dynamic focus capacitor 20. Then, the leads extending below the diodes D0 through D6 can be positioned near the dynamic focus capacitor 20. Positive pulses are generated in the leads extending below the diodes D0 through D6. Thus, the negative pulses generated in the secondary winding 16 are canceled by the positive pulses generated in the leads of the diodes D0 through D6, thereby suppressing noise components to a low level.

As discussed above, in the flyback transformer 10 constructed in accordance with the present invention, the dynamic focus capacitor 20 can be disposed in the vicinity of the coil 12, thereby decreasing the size of the casing 24. As a result, the overall flyback transformer 10 can be reduced in size.

The above-described preferred embodiment of the present invention has been discussed in the context of the dynamic focus capacitor 20. However, another built-in component, such as a flat resistor, may be disposed at the central portion of the winding length of the coil 12 or in the vicinity of the diodes D0 through D6. In this case, the adverse influence of pulses on the flat resistor can also be inhibited.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A flyback transformer comprising a coil including a secondary multi-layered winding which is divided by a dividing diode, a diode being connected to a low potential-side of said secondary multi-layered winding,
wherein a built-in component is disposed at a position corresponding to a central portion of a winding length of said coil.

2. A flyback transformer comprising a coil including a secondary multi-layered winding which is divided by a dividing diode, a diode being connected to a low potential-side of said secondary multi-layered winding,
wherein a built-in component is disposed in the vicinity of said dividing diode.

3. The flyback transformer of claim 1, wherein said built-in component comprises a capacitor connected to an input portion into which a signal for obtaining a dynamic focus output is provided.

4. The flyback transformer of claim 2, wherein said built-in component comprises a capacitor connected to an input portion into which a signal for obtaining a dynamic focus output is provided.

5. The flyback transformer of claim 1, wherein the dividing diode comprises a plurality of diodes each connected between windings of said secondary multi-layered winding.

6. The flyback transformer of claim 2, wherein the dividing diode comprises a plurality of diodes each connected between windings of said secondary multi-layered winding.

7. The flyback transformer of claim 1 wherein positive and negative pulses are induced in said built-in component by said secondary winding, thereby substantially cancelling said positive and negative pulses said built-in component.

8. The flyback transformer of claim 2 wherein the built-in component is disposed off center from the central portion of the winding length of said coil, with said dividing diode also disposed likewise off center form the central portion, whereby induced pulses generated by the secondary winding in the built-in component are substantially cancelled by induced pulses generated in leads of the dividing diode in the built-in component.
